(19) United States
(12) Patent Application Publication
(10) Pub. No.: US 2026/0257609 A1
(43) Pub. Date: Sep. 3, 2026

(54) CRYOGENIC COOLING SYSTEM

(71) Applicant: ABSOLUT SYSTEM, Eybens (FR)

(72) Inventors: Jerome LACAPERE, ST ETIENNE DE CROSSEY (FR); Elias REHAYEM, GRENOBLE (FR)

(21) Appl. No.: 18/841,413

(22) PCT Filed: Feb. 24, 2023
(86) PCT No.: PCT/FR2023/050267

§ 371 Date: Aug. 26, 2024

(30) Foreign Application Priority Data
Feb. 25, 2022 (FR) 2201706

(51) Int. Cl. B60P 3/20; F25B 9/00; F25B 9/14; F25J 1/00; F25J 1/02

(52) U.S. Cl. CPC B60P 3/20; F25B 9/002; F25B 9/145; F25J 1/001; F25J 1/005; F25J 1/0065; F25J 1/0236; F25J 1/0259; F25J 1/0275; F25J 1/0296; F25J 2210/42; F25J 2210/90; F25J 2270/14; F25J 2270/908; F25J 2270/91; F25J 2290/34

(57) ABSTRACT

The invention relates to a mobile cryogenic cooling system comprising: o at least one compressor (1a, 2a) to compress a cryogenic gas and at least one radiator (1b, 2b) to cool the compressed cryogenic gas, o at least one expansion valve (4), o a heat exchanger (5) suitable for being connected to a cooling apparatus, o two regenerators (7, 8), suitable for exchanging heat energy between the compressed cryogenic gas and the expanded cryogenic gas downstream of the heat exchanger (5), characterised in that it comprises at least one intermediate heat exchanger (10), cooled by a cooling device (14), and in that the intermediate heat exchanger (10) is arranged so as to cool the cryogenic gas from the first regenerator (7) before the cryogenic gas flows into the second regenerator, the expansion valve (4) being arranged downstream of the second regenerator so as to cool the gas to a cryogenic temperature.

### FIELD OF THE INVENTION

This invention relates to a mobile cryogenic cooling system.

### PRIOR ART

A cooling system of Turbo-Brayton type uses compression, cooling and expansion processes to obtain cooling by adiabatic expansion of a gas initially at ambient temperature.

Such a cooling system can have several levels of compression by successive compressors. Each compression gives rise to a heating of the compressed gas. In general, the compression of the gas is done at ambient temperature and a radiator or another cooling device is used downstream of each compressor in such a way as to cool the compressed gas to a temperature close to ambient temperature, by dissipating energy from the compressed gas. The compressed gas is then greatly cooled in a recuperator exchanger and then reaches its minimum temperature by expansion downstream of said recuperator exchanger. The gas can therefore be used for the envisioned application, for example the cooling of a superconductive device such as a propulsion engine, or the liquefaction of another gas such as hydrogen.

During use, the temperature of the gas increases following the thermal exchange with the device to be cooled. The gas is then re-used as a cold source to cool the compressed gas in the recuperator exchanger and its temperature increases to a value close to ambient temperature. In general, the gas is directly reintroduced into the system of successive compressions.

For the cooling of the electrical propulsion means using superconductive elements, efficient recuperator exchangers are required for the exchange of heat between a low temperature of approximately 20K and a high temperature which is slightly above the temperature of the system environment, which is typically around 290K on the ground and can drop to approximately 220K for an airplane at altitude.

For the condensation or liquefaction of hydrogen from cold vapor, the low temperature is of 205 K, requiring recuperator exchangers which also offer very high performance.

FIG. 1 illustrates such a cooling system. After the steps of compression in the compressors 1a and 2a, the compressed gas is cooled to ambient temperature by the radiators 1b and 2b. The gas is then cooled to a temperature of approximately 20-25 K by passing through a recuperator exchanger 3 in the duct 3a. After it has passed through, the gas is expanded in an expansion member 4 which is typically an expansion turbine. On leaving the expansion member 4, the gas reaches a temperature of 17-18 K and is therefore able to cool an application 50 such as a superconductive engine to 20 K.

After the thermal exchange 55 in the exchanger 5, the gas temperature approaches 20K. By way of the duct 3b, the gas is conveyed back into the recuperator exchanger 3, in which it is used to cool the compressed gas to ambient temperature in the duct 3a. During this final step said gas is heated to a temperature close to ambient temperature and can be reintroduced into the process of successive compressions from the compressor 1a.

Such cooling systems are heavy and very bulky. Even for relatively short cooling periods, for example a flight of short duration, the requisite system has significant bulk and mass since it requires the same components as a system designed for cooling of long duration. Moreover, the power consumption of such systems is high.

### SUMMARY OF THE INVENTION

One aim of the invention is to design a mobile cryogenic cooling system which is lighter and less bulky, with reduced power consumption, comprising:
at least one compressor to compress a cryogenic gas and at least one radiator arranged downstream of said compressor to cool the compressed cryogenic gas.
at least one expander to expand the compressed cryogenic gas,
a heat exchanger suitable for being coupled to an apparatus to be cooled by the expanded cryogenic gas,
two recuperator exchangers, suitable for an exchange of thermal energy between the compressed cryogenic gas upstream of the expander and the expanded cryogenic gas downstream of the heat exchanger,
characterized in that it comprises at least one intermediate thermal exchanger, cooled by a cooling device, and in that the intermediate thermal exchanger is arranged such as to cool the cryogenic gas coming from the first recuperator exchanger before the passing of said cryogenic gas through the second recuperator exchanger, the expander being arranged downstream of said second recuperator exchanger such as to cool said gas to a cryogenic temperature.

Such a system is versatile insofar as its mass and volume can be adapted to the duration of use. A system can thus be designed which has minimal mass and volume for a target temperature and a known duration of use. The system also makes it possible to adapt locally to limitations, since the intermediate exchanger can be cooled by different cold sources.

In certain embodiments, the cooling device comprises a cryogenic fluid ensuring a thermal exchange with the intermediate thermal exchanger. Thus, the weight and bulk can be adapted to the duration of use, such as the duration of a flight for an application in an airplane, by limiting the volume of cryogenic fluid to the volume required for the duration of use of the system. Advantageously, the cryogenic fluid is nitrogen or methane.

In other embodiments, the cooling device comprises at least a cryocooler of Turbo-Brayton type, a cryocooler based on the Stirling cycle or a pulse tube cryocooler.

Advantageously, the efficiency of the first recuperator exchanger is less than the efficiency of the second recuperator exchanger.

Preferably, the heat exchanger is suitable for cooling an apparatus to a temperature between 17 K and 50 K and more advantageously between 17 K and 20 K.

Advantageously, the radiators include attachment elements suitable for retaining said heat exchanger on an outer wall of an aircraft or are thermally connected to a structure cooled by the outside environment of said aircraft.

The invention thus relates to an electrical-propulsion vehicle or aircraft using at least one superconductive element comprising a cryogenic cooling system as described above, said cooling system being arranged such as to thermally couple the heat exchanger to the at least one superconductive element to be cooled. Preferably, the radiators are arranged on an outer wall of said vehicle or aircraft or in thermal exchange with the outside environment of said vehicle or aircraft.

Advantageously, said electrical-propulsion vehicle or aircraft comprises a fluid connector able to fluidly connect the cold source to a cryogenic cold source to cool the thermal exchanger to a cryogenic temperature. Advantageously, said electrical-propulsion vehicle or aircraft further comprises a cryogenic fluid tank arranged in said vehicle or aircraft, said cryogenic fluid being in fluid coupling with the intermediate thermal exchanger to cool said thermal exchanger to a cryogenic temperature.

The invention also relates to a hydrogen liquefaction installation, comprising a vehicle, a container or an aircraft, a cryogenic cooling system as described above, arranged in said vehicle, container or aircraft, said installation being arranged so as to thermally couple the heat exchanger to a hydrogen source to be liquefied or a superconductive element. In certain embodiments, said hydrogen liquefaction installation comprises a cryogenic fluid tank arranged in said vehicle or container or aircraft, said tank being in fluid coupling with the intermediate thermal exchanger to cool said intermediate thermal exchanger to a cryogenic temperature using the cryogenic fluid. In other embodiments, the hydrogen liquefaction installation comprises a connector suitable for setting up a fluid coupling between the intermediate thermal exchanger and a cryogenic fluid tank outside said vehicle, container or aircraft, to cool said intermediate thermal exchanger to a cryogenic temperature.

The invention also relates to a cryogenic cooling method, comprising the following steps:
one or more steps of compression of a cryogenic gas in a compressor and a step of cooling said compressed gas by a radiator after each compression step,
the passing of said gas through a first recuperator exchanger such as to cool the compressed gas to a first temperature,
the passing of the gas downstream of the first recuperator exchanger through an intermediate thermal exchanger, cooled by a cooling device, such as to cool the gas coming from the first recuperator exchanger to an intermediate temperature less than the first temperature,
the passing of said gas downstream of the intermediate exchanger through a second recuperator exchanger, such as to cool the gas coming from the intermediate thermal exchanger to a second temperature less than the intermediate temperature,
the expansion of said gas in an expansion member such as to cool said gas to a cryogenic temperature less than the second temperature,
the use of said gas for the cooling of an apparatus to be cooled,
the passing of said gas downstream of the apparatus to be cooled in the second recuperator exchanger and the first recuperator exchanger by recovering the thermal energy of the gas compressed in the circuit.

### BRIEF DESCRIPTION OF THE FIGURES

Other features and advantages of the invention will become apparent from the following detailed description with reference to the appended drawings, wherein:

FIG. 1 is a schematic view of a conventional cryogenic cooling system of Turbo-Brayton type.

FIG. 2 is a schematic view of a cryogenic cooling system according to the invention.

FIG. 3 illustrates the application of a cooling system according to the invention in an aircraft.

FIG. 4 shows the cooling system of FIG. 3 in detail.

FIG. 5 illustrates the application of a cryogenic cooling system according to the invention in a mobile container.

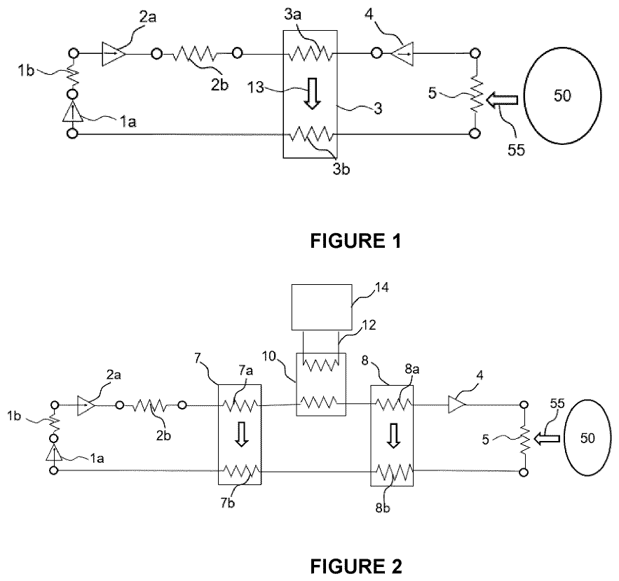

### DETAILED DESCRIPTION OF EMBODIMENTS

### Structure of the Cooling System

FIG. 2 is a schematic view of a cryogenic cooling system according to the invention. The system is mobile in the sense that it is arranged in a means of transport such as a vehicle, a trailer or an aircraft, and/or can be easily boarded on such a means of transport. For example, the system can be installed in a container configured to be transported by a vehicle. The system comprises one or more radiators 1b, 2b each located at the outlet of a respective compressor 1a, 2a. The system further comprises two recuperator exchangers 7 and 8. Each recuperator exchanger comprises a cooling duct 7a, 8a downstream of the radiator or radiators 1b, 2b and upstream of one or more expanders 4, and a recovery duct 7b, 8b in thermal exchange with the cooling duct 7a, 8a of the respective recuperator exchanger 7, 8. The expander is for example an expansion turbine or an expander of Joule-Thompson type. To increase the efficiency of the system, several expanders can be arranged in series or in parallel.

An intermediate thermal exchanger 10 is arranged between the cooling duct 7a of the first recuperator exchanger 7 and the cooling duct 8a of the second recuperator exchanger 8.

The intermediate thermal exchanger provides a cold environment allowing, by heat exchange, the cooling of the gas downstream of the cooling duct 7a of the first recuperator exchanger 7 and upstream of the cooling duct 8a of the second recuperator exchanger 8. In this text the term “cold” should be understood to mean that the area or element in question is at a cryogenic temperature, i.e. a temperature typically less than 150 K.

By way of illustrative and non-limiting example, the intermediate thermal exchanger 10 can be a cryocooler of Turbo-Brayton type or a cryocooler based on the Stirling cycle or a pulse tube or a combination of several cryocoolers of the same type or of different types. Alternatively, the intermediate thermal exchanger 10 can be an exchanger in fluid coupling 12 with a coolant in a tank 14, or submerged in a bath of coolant. In this case, the cryogenic fluid circulates in such a way as to use the heat capacity of said cryogenic fluid for the cooling of the gas downstream of the cooling duct 7a of the first recuperator exchanger 7 and upstream of the cooling duct 8a of the second recuperator exchanger 8. Advantageously, the cryogenic fluid is a cryogenic liquid having a high cryogenic power owing to its latent heat, such as for example liquid nitrogen or liquid methane. In certain embodiments, the intermediate thermal exchanger is a combination of a cryocooler and a device cooled using a cryogenic fluid.

A thermal exchanger 5, arranged downstream of the expander or expanders 4, allows the thermal exchange 55 with the application 50. The application is, by way of illustration and without limitation, a superconductive engine, for example in an aircraft, or a hydrogen cooling or liquefaction system.

Said thermal exchanger 5 is fluidly coupled to the recovery duct 8b of the second recuperator exchanger 8, which is in turn in fluid coupling with the recovery duct 7b of the first recuperator exchanger 7.

A duct able to reintroduce the gas into the compressor 1a is arranged downstream of the recovery duct 7b of the first recuperator exchanger 7.

### Operation of the Cooling System

To cool an application 50, a cryogenic gas contained in the system is compressed in the compressors 1a and 2a, such a compression producing a heating of said gas. Preferably, said cryogenic gas is helium. Alternatively, the gas can be a mixture of helium and neon, or hydrogen, or else a mixture of hydrogen and neon, or a mixture of the three fluids mentioned. After each step of compression, the compressed gas is cooled to a temperature close to the ambient temperature of the system by a radiator 1b or 2b. The ambient temperature is typically around 290K on the ground and can drop to approximately 220K for an aircraft at altitude.

The compressed gas is then cooled to a first low temperature, for example of 90 K by passing through the recuperator exchanger 7 in the duct 7a. The gas is then cooled by the intermediate thermal exchanger 10 to an intermediate temperature, for example to 80 K.

The gas downstream of the intermediate exchanger is cooled to a second low temperature, for example of 22 K, by passing through the recuperator exchanger 8 in the duct 8a. The intermediate temperature is less than the first low temperature, and greater than the second low temperature.

After it has passed through, the gas is expanded in the expander or expanders 4. At the outlet of the expander or expanders 4, the gas reaches its minimal temperature (less than 20 K) and is conveyed into the exchanger 5 thermally connected to the envisioned application 50.

After the thermal exchange 55 in the exchanger 5, the temperature of the gas approaches the temperature of the application 50. By way of the duct 8b, the gas is conveyed back into the second recuperator exchanger 8, in which it is used to cool the compressed gas to the intermediate temperature in the duct 8a. Next, by way of the duct 7b, the gas is conveyed back into the first recuperator exchanger 7, in which it is used to cool the compressed gas to ambient temperature in the duct 7a. During this last step said gas is heated to a temperature close to the ambient temperature and can be reintroduced into the process of successive compressions from the compressor 1a.

### Applications

By way of illustrative example and without limitation, the system can be used for the cooling of the superconductive components of an engine, for example for the propulsion of an aircraft.

Such an engine for an aircraft may comprise components, for example electromagnetic coils, made of superconductive material, allowing an increase in the power of the machine. These components must be kept at a temperature less than the lowest critical temperature of the superconductive components for the duration of operation of the engine.

The system can also be used to cool a superconductive generator or any other superconductive system, for example a cable or a current limiter. In this case, the cryogenic gas temperature at the inlet of the exchanger 5 is typically close to 20 K. The system is therefore able to cool the superconductive element to a temperature between 20 and 50 K.

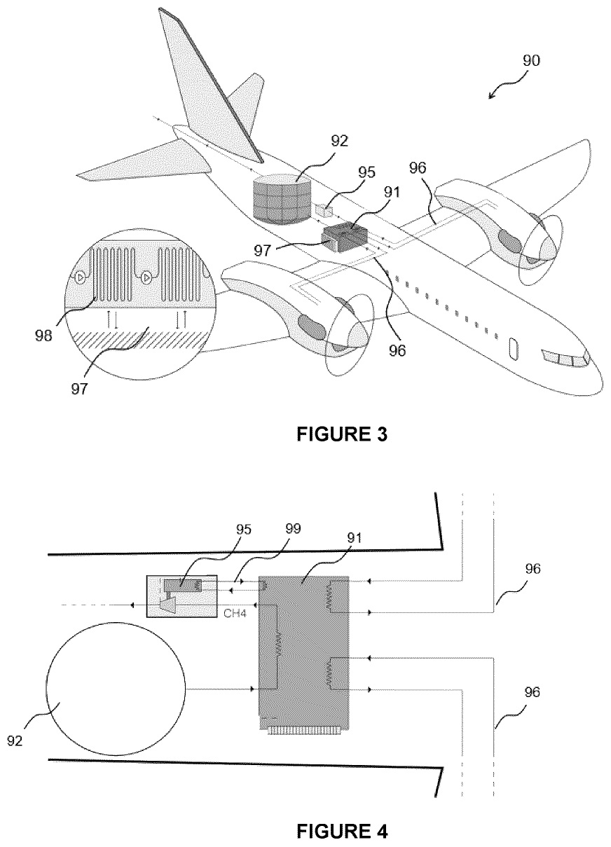

FIG. 3 illustrates an aircraft 90 equipped with a turbo generator 95 to be cooled, with two superconductive engines to be cooled, and a cooling system 91 according to the invention. The aircraft 90 comprises a tank 92 containing a cryogenic liquid, for example liquid methane at 110K, intended to cool the turbo generator 95 used to generate the electrical energy necessary for the operation of the aircraft. This liquid methane is moreover used to cool the intermediate thermal exchanger of the cooling system 91.

The cooling system 91 comprises two radiators 98 at the outlet of the 2 compressors. The radiators 98 are arranged in proximity to the wall 97 allowing thermal contact with the air outside the aircraft, which corresponds to a temperature of approximately 220 K at altitude. Alternatively, a thermal exchanger can be used to set up a thermal contact between the outside air and the radiators 98.

With reference to FIG. 4, the cryogenic liquid in the tank 92 is used for the cooling of the intermediate thermal exchanger of the cooling system 91, and then used for the cooling of the turbo generator 95 for the production of electrical energy. The cooling ducts 99 of the generator 95 and the cooling ducts 96 of the superconductive engines are cooled by the cooling system 91 to a temperature close to 20 K.

Alternatively, the system can be used for the liquefaction or re-liquefaction of hydrogen or the cooling of liquid hydrogen during its storage. The term “liquefaction” should be understood to mean a method of making the hydrogen transition from a gaseous state to a liquid state starting from hydrogen at ambient temperature, i.e. a temperature of approximately 280-300 K, which involves cooling the hydrogen and then liquefying it. The term “re-liquefaction” or “condensation” should be understood to mean a method of making the hydrogen transition from a gaseous state to a liquid state, starting from cold vapors which have just been generated by evaporation of a part of the liquid hydrogen and which are still cold, i.e. at a temperature close to that of liquid hydrogen. The re-liquefaction or condensation therefore only involves liquefying hydrogen without making it go through a cooling phase, since the vapors are already cold. The term “subcooling” should be understood to mean a method of cooling liquid hydrogen to a temperature less than the liquefaction temperature.

For the liquefaction, re-liquefaction or subcooling of hydrogen, the temperature of the cryogenic gas at the inlet of the exchanger 5 is of 17-35K. Said gas is therefore able to liquefy hydrogen to a temperature between 20 and 35 K, or to subcool liquid hydrogen to a temperature between 20 and 30K. The heat exchanger 5 must be suitable for operating at a temperature between 17 K and 35 K and more advantageously between 17 K and 25 K.

During the storage of hydrogen at a cryogenic temperature, continuous cooling is maintained in order to limit a pressure increase in the storage tank and avoid hydrogen losses by evaporation. Alternatively, the cooling can be applied intermittently at regular intervals, by letting the pressure in the tank rise to a limit pressure then initiating cooling to decrease the pressure.

The hydrogen can be used to power a fuel cell or a hydrogen combustion engine, or in aeronautical applications. A cooling system can thus be used in aeronautics for the simultaneous cooling of a quantity of hydrogen and a number of superconductive components.

### Use and Advantages

The intermediate thermal exchanger 10 is used to cool the cryogenic gas during its high-pressure flow to an intermediate temperature, higher than the cold temperature required by the application. The first recuperator exchanger 7 is used to reduce the temperature upstream of the intermediate thermal exchanger. The more additional cooling the intermediate thermal exchanger 10 provides, the less cooling power the first recuperator exchanger requires, and conversely. One can therefore adjust the powers of the first recuperator exchanger 7 and of the intermediate thermal exchanger 10 according to the limitations of the environment in which the cooling system is used.

The first recuperator exchanger 7 can therefore be considerably less bulky and less heavy than a recuperator exchanger in a known cooling system as described above, supplying the same cold temperature. The second recuperator exchanger 8 is used downstream of the intermediate thermal exchanger 10 closer to that required by the application. As regards the second recuperator exchanger 8, a lower cooling power than that in a known system is enough to obtain the desired cooling. The electrical power consumption of each compressor 1a, 2a downstream of the first recuperator exchanger 7 is reduced.

The second recuperator exchanger 8 can therefore be considerably less bulky and less heavy than a recuperator exchanger in a known cooling system supplying the same cold power at the same cold temperature.

Owing to the intermediate thermal exchanger 10, the flow rate of the cooling cycle can be reduced by a factor of approximately 2 or 3 by comparison with a known cooling system, to obtain an identical transmitted power at the exchanger 5.

For example, at a cold temperature of 20 K at a given power, the volume and the mass of each recuperator exchanger can be reduced by a factor of between 4 or 5 by comparison with that of a recuperator exchanger in a known cooling system and the electrical power consumption of each compressor is reduced by a factor of between 3 and 4.

Even considering the need for two recuperator exchangers and an intermediate thermal exchanger, a system according to the invention allows a reduction in mass and bulk and simultaneously a reduction of the electrical power consumption as a function of the components used by comparison with a known cooling system.

The second recuperator exchanger 8 requires a certain level of efficiency in order to reach the second low temperature, which is for example of approximately 20 K. Advantageously, the first recuperator exchanger 7 has a lower efficiency which is generally enough for the cooling to the first low temperature and makes it possible to dimension the first recuperator exchanger to be lighter and less bulky.

In particular, when the cooling is to be done for a limited duration, for example a flight of short duration, the intermediate thermal exchanger can be supplied with a limited quantity of cryogenic fluid, cooled before the flight by a ground system. One can thus dimension the mass and bulk of the cooling system according to the requisite duration of the cooling.

In this way cooling of limited duration can be carried out during a vehicle journey, a transportation of a container, for example by a boat or vehicle, or an aircraft flight. In this case, said vehicle, container or aircraft comprises a cooling system in which at least a part of the cooling of the intermediate thermal exchanger 10 is done by a cryogenic fluid. The vehicle, container or aircraft further comprises a tank suitable for storing a sufficient quantity of cryogenic fluid for the planned journey. Advantageously, the vehicle, container or aircraft further comprises a connector able to fluidly connect the cold source to a source of cryogenic fluid on the ground. The tank can thus be filled before the journey or flight in order to cool the thermal exchanger to a cryogenic temperature during the journey or flight. Thus, the total mass of the cooling system is minimized as a function of the cryogenic temperature used and the duration of the flight

In other cases, the cryogenic cooler is arranged in a mobile container, which can be arranged on board a vehicle or aircraft. The cooling is done when said container is at rest. The cooling of the intermediate thermal exchanger can be done using a cold source arranged at a fixed location. For example, the intermediate thermal exchanger is in fluid connection with a storage tank of liquid nitrogen. This solution also makes it possible to minimize the total mass of the system intended to be transported.

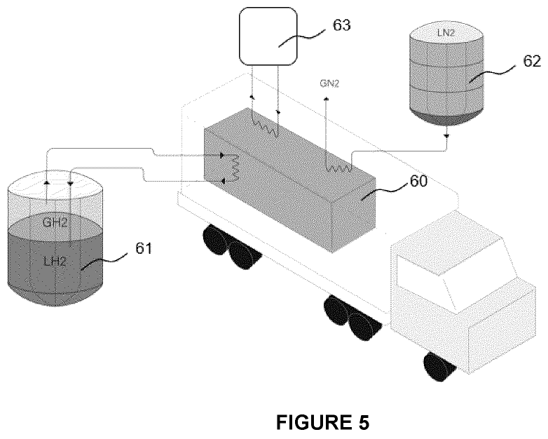

FIG. 5 illustrates the cooling system arranged in a mobile container 60 mounted on a truck. The cooling system can be connected to an external electricity source 63 and to an outside tank 62 filled with a cryogenic fluid, for example liquid nitrogen. Thus, the cooling system can be designed to be less bulky and less heavy than a known cooling system, and be supplied by sources of electricity and cryogenic liquid available in the location where it is used. The system can be used for the liquefaction and re-liquefaction of liquid hydrogen in a tank 61, or for any other cryogenic application.

Table 1 illustrates the power consumption, mass and cryogenic fluid requirement in the cases of different cooling systems supplying a power of 1 kW at a temperature of 20K. In this table only the main loop of the cooling system, through which the cryogenic fluid circulates, is considered, and not the secondary loop which, in the invention, provides the cooling power required for the intermediate thermal exchanger.

TABLE 1

| | | | Mass of |
|---|---|---|---|
| | | | liquid |
| | Power | | nitrogen |
| | consumption | Mass of | equivalent |
| | of the | the main | to supply |
| 1 kW to 20K | main loop | loop | 5 kW at 80K |
| Known turbo-Brayton cooling | 200 kW | 1000 kg | |
| system | | | |
| Cooling system according to | 135 kW | 580 kg | |
| the invention with | | | |
| intermediate thermal | | | |
| exchanger of turbo-Brayton | | | |
| type providing 5 kW at 80K | | | |
| Cooling system according to | 60 kW | 250 kg | ~82 kg/hr |
| the invention with | | | |
| intermediate thermal | | | |
| exchanger supplied with liquid | | | |
| nitrogen providing 5 kW at | | | |
| 80K | | | |

A cooling system of known turbo-Brayton type (first row of the table) supplying such a power of 1 kW at a temperature of 20K has a mass of 1000 kg and an electrical power consumption of 200 kW.

According to a first alternative provided by the invention (second row of the table), one can obtain the same cooling power at a temperature of 20K using a cooling system comprising an intermediate thermal exchanger cooled by a machine of turbo-Brayton type providing a power of 5 KW at 80K. The electrical power consumption of the main loop of such a system is of 135 KW and its mass is of approximately 580 kg. The assembly formed by the main loop and the secondary loop has a lesser electrical power consumption and mass than those of the known system. It is thus possible to design lighter systems, which makes it possible to board them on an aircraft and a vehicle and also to make savings on fuel for applications on board an aircraft or vehicle.

According to a second alternative procured by the invention (third row of the table), one can obtain the same cooling power of 1 KW at a temperature of 20K using a cooling system comprising an intermediate thermal exchanger cooled by liquid nitrogen providing a power of 5 KW to 80K. The electrical power consumption of the main loop of the cooling system amounts to 60 KW and the mass of the system is of 250 kg. The electrical power consumption of the secondary loop amounts to 75 KW. The assembly formed by the main loop and of the secondary loop has a lesser electrical power consumption and mass than those of the known system. During its operation, the system also consumes approximately 82 kg of liquid nitrogen per hour. For example, for a flight of a duration of 3 hours, this equates to a mass of liquid nitrogen of 246 kg, and a mass of the cooling system comprising this quantity of liquid nitrogen of 446 kg. For shorter periods of time, the system requires a smaller quantity of coolant such as liquid nitrogen and therefore has a still lower mass and bulk. One can thus design cooling systems which are modular, lighter and more compact for shorter durations of flight.

Moreover, in the case of use in a vehicle or aircraft, the radiators 1a and 1b can be arranged in thermal contact with the outside environment of the aircraft, for example on an outer wall of the aircraft using attachment elements suitable for retaining the radiators 1a and 1b on such a wall during the flight. Alternatively, the radiators 1a and 1b can be arranged on a heat-conducting wall in thermal contact with the outside environment, or in thermal contact using slots, grilles or other openings allowing an exchange with the air outside the vehicle or aircraft.

This embodiment is very advantageous for use in an aircraft travelling at altitude. For example, at an altitude of 10 km from the ground, the temperature outside the aircraft can decrease to approximately 220K. Going from an ambient temperature of around 300K to an environment such as the outside of an aircraft, the cooling requirements for obtaining the intermediate temperature decrease. For aeronautical applications, the cooling system according to the invention thus makes it possible to make further savings in mass and bulk.

For the example of a cooling system supplying a power of 1 KW at a cold temperature of 20K using an intermediate thermal exchanger of a power of 5 kW at an intermediate temperature of 80K, a drop in the ambient temperature of 300 K on the ground at 220 K at 10 km of altitude gives rise to a drop in the coolant requirement by the intermediate thermal exchanger at 2.5 KW for an intermediate temperature of 80K. If liquid nitrogen is used to cool the intermediate thermal exchanger, the consumption of liquid nitrogen is reduced by a factor of 2.

In addition, superconductive engines for aircraft are generally dimensioned for the flight phases requiring maximum engine power, in particular the take-off phase. The cryogenic cooler is then dimensioned for maximum engine power. When the aircraft is in cruise phase or in landing phase, the powers of the engine and of the cryogenic cooling system are lower. One can therefore adapt the cooling supplied by the intermediate thermal exchanger and, optionally, its cryogenic fluid requirement. Such an adaptation makes it possible to further reduce the mass and bulk of the cooling system by more precisely adapting the quantity of fluid used for intermediate cooling.

1. A mobile cryogenic cooling system comprising:
at least one compressor to compress a cryogenic gas and at least one radiator arranged downstream of said compressor to cool the compressed cryogenic gas,
at least one expander to expand the compressed cryogenic gas,
a heat exchanger suitable for being coupled to an apparatus to be cooled by the expanded cryogenic gas,
two recuperator exchangers, suitable for an exchange of thermal energy between the compressed cryogenic gas upstream of the expander and the expanded cryogenic gas downstream of the heat exchanger,
the system comprising at least one intermediate thermal exchanger, cooled by a cooling device,
wherein the intermediate thermal exchanger is arranged such as to cool the cryogenic gas coming from the first recuperator exchanger before the passing of said cryogenic gas through the second recuperator exchanger, the expander being arranged downstream of said second recuperator exchanger such as to cool said gas to a cryogenic temperature.

2. The system as claimed in claim 1, wherein the cooling device comprises a cryogenic fluid ensuring a thermal exchange with the intermediate thermal exchanger.

3. The system as claimed in claim 2, wherein the cryogenic fluid is nitrogen or methane.

4. The system as claimed in claim 1, wherein the cooling device comprises at least a cryocooler of Turbo-Brayton type, a cryocooler based on the Stirling cycle or a pulse tube cryocooler.

5. The system as claimed in claim 1, wherein an efficiency of the first recuperator exchanger is less than an efficiency of the second recuperator exchanger.

6. The system as claimed in claim 1, wherein the heat exchanger is configured for cooling an apparatus to a temperature between 17 K and 50 K and more advantageously between 17 K and 20 K.

7. The system as claimed in claim 1, wherein the radiators include attachment elements suitable configured for retaining said heat exchanger on an outer wall of an aircraft or are thermally connected to a structure cooled by an outside environment of said aircraft.

8. An electrical-propulsion vehicle or aircraft using at least one superconductive element comprising a cryogenic cooling system as claimed in claim 1, said cooling system being arranged such as to thermally couple the heat exchanger to the at least one superconductive element to be cooled.

9. The vehicle or aircraft as claimed in claim 8, wherein the radiators are arranged on an outer wall of said vehicle or aircraft or in thermal exchange with the outside environment of said vehicle or aircraft.

10. The vehicle or aircraft as claimed in claim 8, comprising a fluid connector configured to fluidly connect the cold source to a cryogenic cold source to cool the thermal exchanger to a cryogenic temperature.

11. The vehicle or aircraft as claimed in claim 8, comprising a cryogenic fluid tank arranged in said vehicle or aircraft, said cryogenic fluid being in fluid coupling with the intermediate thermal exchanger to cool said thermal exchanger to a cryogenic temperature.

12. A hydrogen liquefaction installation, comprising a vehicle, a container or an aircraft, a cryogenic cooling system as claimed in claim 1 arranged in said vehicle, container or aircraft, said installation being arranged so as to thermally couple the heat exchanger to a hydrogen source to be liquefied or a superconductive element.

13. The hydrogen liquefaction installation as claimed in claim 12, comprising a cryogenic fluid tank arranged in said vehicle or container or aircraft, said tank being in fluid coupling with the intermediate thermal exchanger to cool said intermediate thermal exchanger to a cryogenic temperature owing to the cryogenic fluid.

14. The hydrogen liquefaction installation as claimed in claim 12, comprising a connector suitable for setting up a fluid coupling between the intermediate thermal exchanger and a cryogenic fluid tank outside said vehicle, container or aircraft, to cool said intermediate thermal exchanger to a cryogenic temperature.

15. A cryogenic cooling method, comprising:
one or more steps of compression of a cryogenic gas in a compressor and a step of cooling said compressed gas by a radiator after each compression step,
passing of said gas through a first recuperator exchanger such as to cool the compressed gas to a first temperature,
passing of the gas downstream of the first recuperator exchanger through an intermediate thermal exchanger, cooled by a cooling device, such as to cool the gas coming from the first recuperator exchanger to an intermediate temperature less than the first temperature,
passing of said gas downstream of the intermediate exchanger through a second recuperator exchanger, such as to cool the gas coming from the intermediate thermal exchanger to a second temperature less than the intermediate temperature,
expansion of said gas in an expansion member such as to cool said gas to a cryogenic temperature less than the second temperature,
use of said gas for cooling an apparatus to be cooled,
passing of said gas downstream of the apparatus to be cooled in the second recuperator exchanger and the first recuperator exchanger by recovering a thermal energy of the gas compressed in the circuit.
